(19) United States
(12) Patent Application Publication
(10) Pub. No.: US 2015/0366275 A1
(43) Pub. Date: Dec. 24, 2015

(54) Wearable Signaling Device

(71) Applicant: Gyula Cserfoi, Vancouver, WA (US)

(72) Inventor: Gyula Cserfoi, Vancouver, WA (US)

(21) Appl. No.: 14/693,434

(22) Filed: Apr. 22, 2015

Related U.S. Application Data
(60) Provisional application No. 62/014,263, filed on Jun. 19, 2014.

(51) Int. Cl. A41D 13/01; F21L 4/00; F21V 21/08; F21V 23/04; F21V 33/00; F21V 23/00

(52) U.S. Cl. CPC A41D 13/01; F21V 33/0076; F21V 23/003; F21V 21/0816; F21V 23/0414; F21L 4/00; F21W 2101/023

(57) ABSTRACT

A wearable signaling device for use by bicyclists. The wearable signaling device includes one or more adjustable straps to be disposed on a limb of a user, such as the user's arms or legs. The straps may be elastic or can include hook and loop fastening material thereon. The straps further include a light assembly permanently or removably supported thereon, wherein the light assembly helps to increase the visibility of the user while riding a bicycle. Further, the light assemblies can be used to indicate the direction in which the user is turning. A hand-operated control is provided that allows the user to indicate which direction he or she wishes to turn by illuminating the lights on the left or right side of the user's body. Thus, the present invention helps to increase the visibility of bicyclists and helps bicyclists to easily indicate their turns to pedestrians and drivers alike.

### CROSS REFERENCE TO RELATED APPLICATION

This application claims the benefit of U.S. Provisional Application No. 62/014,263 filed on Jun. 19, 2014. The above identified patent application is herein incorporated by reference in its entirety to provide continuity of disclosure.

### BACKGROUND OF THE INVENTION

1. Field of the Invention

The present invention relates to a wearable signaling device. More specifically, the present invention provides a signaling device for use by bicyclists, skateboarders, roller-skaters, and the like. The wearable signaling device includes a plurality of straps having light assemblies therein, wherein the light assemblies can be selectively illuminated using a hand-operated control that can be operated so as to indicate the direction in which the user wishes to turn.

Bicyclists often share roadways with automobiles which can be dangerous for the bicyclist. Unlike automobiles, bicycles lack indicator lights adapted to notify to other motorists the direction in which way the bicycle wishes to turn or if the bicyclist wishes to change lanes. This exposes the bicyclist to the risk of an accident when turning or changing lanes if the motorists nearby are not paying attention to the bicyclist's actions.

Thus, when bicyclists are using a roadway shared by automobiles, it is important for bicyclists to signal their turns with hand signals in order to inform automobile drivers of the bicyclist's route. However, it can be unclear to many drivers whether the bicyclist is signaling, or what action the bicyclist is trying to signal. This is particularly true at night and in periods of low light in which the bicyclist's arms or hands are not easily visible. Further, hand signals require the bicyclist to take one of his or her hands off of the bicycle, which may be dangerous for the bicyclist.

The present invention provides a wearable signaling device for use by bicyclists. The signaling device comprises a plurality of straps adjustably securable on a limb of a user, such as the user's arms or legs. Each of the straps includes a light assembly permanently or removably supported thereon. A hand-operated control allows the user to selectively illuminate the lights so as to indicate whether the user is turning right or left. The hand-operated control may control the light assemblies wirelessly or via a wired connection.

2. Description of the Prior Art

Devices have been disclosed in the prior art that relate to wearable signaling systems. These include devices that have been patented and published in patent application publications. These devices generally relate to garments or harnesses to be worn on the upper body of a user that is bicycling, roller-skating, skateboarding, or performing another similar activity. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 6,925,654 to De Silva discloses a safety signal jacket for bicyclists, roller-skaters, and the like. The jacket includes a signal apparatus and a horn apparatus to alert and warn other drivers and pedestrians. The signal apparatus electrically communicates with switch panel assemblies and a power source to cause the signal lights to illuminate and flash. Push button switches activate and control the signal lights, wherein the switches are located on the shoulder straps. Thus, while De Silva discloses a signal jacket, the jacket does not include conical lights, and does not include a hand-operated control for activating the lights.

U.S. Pat. No. 5,690,411 to Jackman discloses a wearable signaling system. The device includes direction signaling light assemblies supported on a vest-type garment. A panel of switches is used to control the signaling light assemblies and is positioned on the vest-type garment and can be secured to the handlebars of a bicycle. Therefore, Jackman discloses a wearable signaling device resembling a vest and does not include adjustable straps with lights thereon. Further, Jackman does not disclose the use of conical lights for improving the user's visibility.

U.S. Patent Application Publication Number 2006/0291192 to Hill discloses an illuminating garment including one or more illumination members and a power source. The illumination members may be electrically connected to a motorcycle's brake and turn signal system. A system for bicyclists includes a control unit for the bicyclist to input brake and turn commands. Thus, Hill discloses an illuminated garment having strips of lights and does not disclose adjustable straps having conical lights thereon that are in wireless communication with a hand-operated control.

U.S. Patent Application Publication Number 2004/0156215 to Woolridge discloses an instrumented garment including a vest. The vest includes LEDs on the rear thereof. The lights are capable of receiving signals from vehicles. Thus, Woolridge does not disclose a wearable signaling device having conical lights and having a hand-operated control for illuminating the lights.

Finally, U.S. Pat. No. 5,070,436 to Alexander et al. discloses a signal vest composed of brightly colored material and reflective material. Further, the vest has flashing lights that are controlled by self-contained electrical circuits. A switch is provided to turn the vest on or off. Thus, Alexander et al. discloses a garment with lights for signaling, but does not disclose a garment adapted to be used by a bicyclist to indicate the bicyclist's turns.

These prior art devices have several known drawbacks. The devices in the prior art provide garments having lights thereon for signaling. Wearing a vest or jacket can be inconvenient for the user, particularly if the user is already wearing a coat or jacket. The devices in the prior art fail to disclose a signaling device comprising adjustable straps having light assemblies thereon, wherein the straps can be secured to various portions of the user's body as desired by the user. Further, the devices in the prior art do not disclose conical lights that extend outward from the user's body. The conical lights provide enhanced visibility, allowing the user to be more easily seen by drivers in any position around the user.

In light of the devices disclosed in the prior art, it is submitted that the present invention substantially diverges in design elements from the prior art and consequently it is clear that there is a need in the art for an improvement to existing wearable signaling devices. In this regard the instant invention substantially fulfills these needs.

### SUMMARY OF THE INVENTION

In view of the foregoing disadvantages inherent in the known types of wearable signaling devices now present in the prior art, the present invention provides a new wearable signaling device wherein the same can be utilized for providing convenience for the user when riding a bicycle on a roadway shared by automobiles or in an area with pedestrians.

It is therefore an object of the present invention to provide a new and improved wearable signaling device that has all of the advantages of the prior art and none of the disadvantages.

It is another object of the present invention to provide a wearable signaling device comprising a plurality of adjustable straps securable to various portions of the user's body wherein the straps include light assemblies thereon.

Another object of the present invention is to provide a wearable signaling device comprising adjustable straps having hook and loop fastening material thereon.

Yet another object of the present invention is to provide a wearable signaling device comprising conical shaped lights that are more easily visible for pedestrians and automobile drivers.

Another object of the present invention is to provide a wearable signaling device comprising a plurality of light assemblies operated via a hand-operated control.

A further object of the present invention is to provide a wearable signaling device comprising a plurality of light assemblies that can be selectively illuminated in order to indicate the direction the user wishes to turn.

An additional object of the present invention is to provide a wearable signaling device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the wearable signaling device having a light assembly secured thereon.

FIG. 1B shows a perspective view of an embodiment of the wearable signaling device having a light assembly removed therefrom.

FIG. 2 shows a perspective view of a light assembly of the present invention.

FIG. 3 shows a rear view of the wearable signaling device as worn by a user.

FIG. 4 shows a view of the control unit of the wearable signaling device.

FIG. 5 shows a schematic diagram of the operation of the wireless embodiment of the wearable signaling device of the present invention.

### DETAILED DESCRIPTION OF THE INVENTION

Reference is made herein to the attached drawings. Like reference numerals are used throughout the drawings to depict like or similar elements of the wearable signaling device. For the purposes of presenting a brief and clear description of the present invention, the preferred embodiment will be discussed as used for allowing a bicyclist to easily signal to other drivers and pedestrians to indicate the direction in which the bicyclist wishes to turn. The figures are intended for representative purposes only and should not be considered to be limiting in any respect.

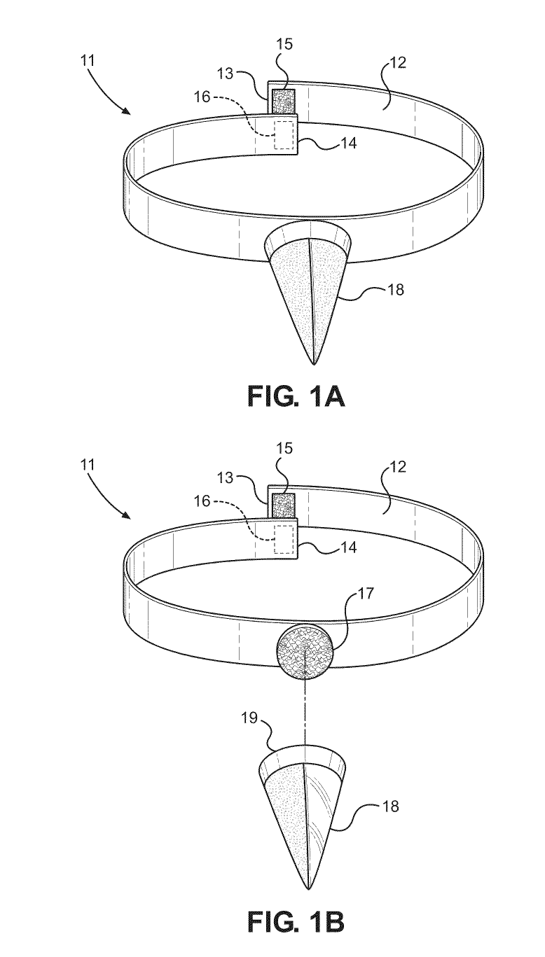

Referring now to FIGS. 1A and 1B, there are shown perspective views of the wearable signaling device of the present invention with and without a light assembly secured thereto, respectively. The wearable signaling device 11 of the present invention comprises an adjustable strap 12 adapted to be secured around a user's limb, such as the user's arm or leg. The adjustable strap 12 may be an elastic loop adapted to stretch to snugly fit onto a portion of the user's arm or leg. Alternatively, and as shown in the illustrated embodiment, the adjustable strap 12 may include a first end 13 and a second end 14, wherein the first end 13 includes a fastener 15 thereon adapted to mate with a fastener 16 on the second end 14 in an overlapping relation. Preferably, the fasteners 15, 16 comprise hook and loop fastening material, but can alternately include other types of fasteners such as buttons or snaps. The adjustable strap 12 may be composed of leather, nylon, plastic, or other suitable materials.

The adjustable strap 12 may include a light assembly 18 permanently affixed thereon or removably supported thereon. In embodiments having a removable light assembly 18, the base 19 of the light assembly 18 is adapted to be removably secured to a fastening pad 17 disposed on an exterior surface of the adjustable strap 12. The base 19 and fastening pad 17 may include various types of fasteners thereon, such as hook and loop fastening material, or may be secured via a press fit or threaded engagement. Thus, if the light assembly 18 is broken or otherwise needs to be replaced, the user can simply remove and replace the light assembly 18 on an adjustable strap 12.

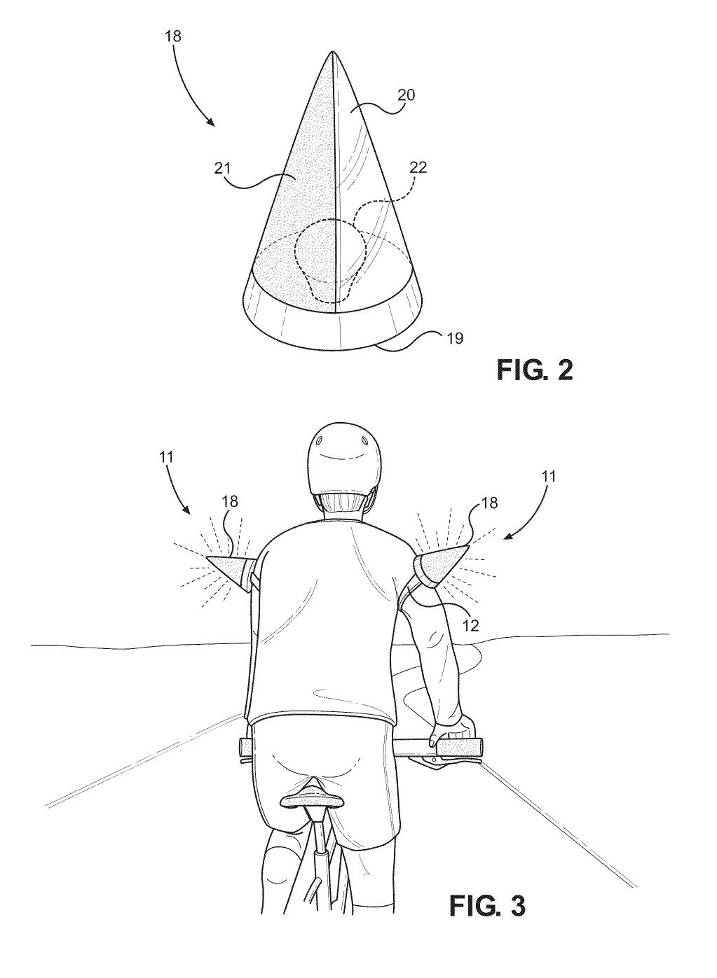

Referring now to FIG. 2, there is shown a perspective view of a light assembly of the present invention. Each light assembly 18 includes a housing having a flat base 19 and an upstanding section. Preferably, the upstanding section comprises a conical shape. However, in alternate embodiments the upstanding section may include a dome or square shape, among others. The base 19 of each light assembly 18 may be permanently or removably secured to an adjustable strap of the present invention via any suitable fasteners, such as hook and loop fastening material, or by means of a press fit or threaded engagement. The housing encloses a power source and a wireless receiver for receiving signals from a control unit of the present invention. The housing further encloses a light source 22 therein, such as an LED light or incandescent bulb. Further, the light assembly provides means for causing the lights to steadily illuminate or flash to indicate that the user is turning. Preferably, the light assembly 18 includes a conical shape so that the light assembly 18 extends outward from the user's body when the adjustable straps are secured to the user. In this way, the light assemblies 18 on the side of the user are more easily viewed by drivers in front of and behind the bicyclist.

The light assembly 18 is preferably colored similarly to the lights on an automobile so that the lights are easily recognizable by other motorists. In some embodiments, the light assembly 18 may be tinted yellow or orange so as to produce yellow or orange light, respectively. In an alternate embodiment, the light assembly 18 may include both white and red portions. In such embodiments, the housing is divided into two equal halves by a plane that cuts through the tip of the cone shape and that is perpendicular to the flat base of the housing. A first half 21 of the conical housing is transparent so that white light shines therethrough, and a second half 20 of the conical housing is tinted red so as to produce red light. In this way, the light assemblies can be secured to the user such that they are white when viewed from the front and red when viewed from the rear.

Referring now to FIG. 3, there is shown a rear view of the wearable signaling device as worn by a user. In operation, the user can secure adjustable straps 12 to various portions of the user's body, such as the user's upper arm as shown in the illustrated embodiment. The user can secure additional adjustable straps 12 to the user's lower arm or wrist, and can secure adjustable straps 12 to the user's ankles or thighs. The adjustable straps 12 are adapted to fit securely on users of various sizes.

In some embodiments, the light assemblies 18 are permanently affixed to the adjustable straps 12, and in other embodiments the light assemblies 18 are removably securable thereto via fasteners. The light assemblies 18 preferably are conical in shape so as to extend outward from the user's body to improve visibility by other motorists and pedestrians. In some embodiments, a first half of the light assembly 18 is tinted red so that the light is red when viewed from the rear, whereas a second half of the light assembly 18 is clear so that the light is white when viewed from the front. In other embodiments, the entire light assembly 18 is a solid orange or yellow color. A hand-operated control is provided that allows the user to selectively illuminate either the light assemblies 18 on the left side of the user, the light assemblies 18 on the right side of the user, or both.

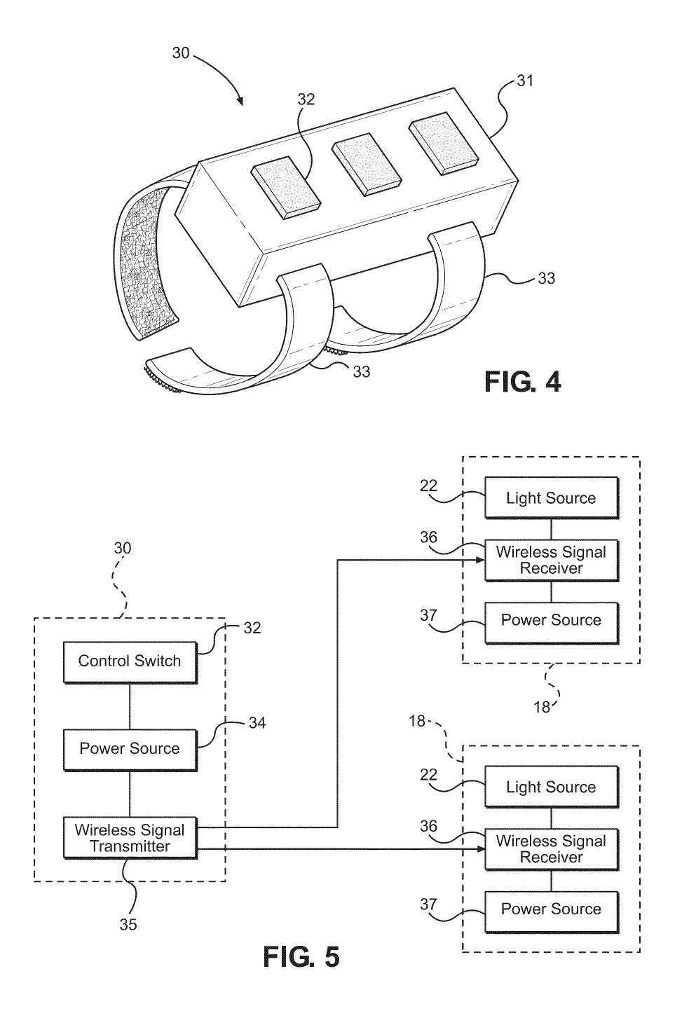

Referring now to FIG. 4, there is shown a view of the hand-operated control of the wearable signaling device. A hand-operated control 30 is provided that allows a user to selectively illuminate the light assemblies of the wearable signaling device. The hand-operated control 30 may be in wired or wireless connection with the light assemblies of the present invention. The hand-operated control 30 allows the user to provide steady illumination of the light assemblies or to flash the lights on either the right half or left half of the user's body in order to indicate that the user is going to turn in that direction. The light assemblies 18 may be marked as being left side light assemblies or right side light assemblies so that the user knows on which side of his or her body to place the light assemblies.

The hand-operated control 30 comprises a housing 31 enclosing a control circuit, a power source, a wireless signal transmitter, and at least one control switch 32 for allowing the user to selectively power the light assemblies. The wireless signal transmitter is adapted to communicate with the plurality of lights on the support in order to cause the light assemblies to operate in the selected manner. Thus, when the user operates a control switch 32, a signal is sent by the wireless signal transmitter to cause the light assemblies on the left half of the user's body to flash, to cause the light assemblies on the right half of the user's body to flash, or to provide steady illumination of the light assemblies. The housing may further include a fastener 33, such as one or more straps, that can be secured around the handlebars of the user's bike or directly to the user's hand or fingers.

Referring now to FIG. 5, there is shown a schematic diagram of the operation of the wireless embodiment of the wearable signaling device of the present invention. The hand-operated control 30 includes a power source 34, a wireless signal transmitter 35 for sending signals to the light assemblies 18, and at least one control switch 32 for operating the light assemblies 18. Each of the plurality of light assemblies 18 includes a light source 22, such as an LED or incandescent bulb, a wireless signal receiver 36 for receiving the signal sent by the hand-operated control 30, and a power source 37. The user can operate a particular control switch 32 to cause the wireless signal transmitter 35 to send a signal causing the light sources 22 to flash on the left or right side of the user's body to indicate a turn, or to remain steadily illuminated when the user is not turning. When the control switch 32 is actuated, the wireless signal transmitter 35 of the hand-operated control is adapted to communicate with the wireless signal receiver 36 of the light assembly 18 that the user desires to illuminate. In some embodiments, the hand-operated control may further include a microprocessor for determining which light assemblies 18 are to be illuminated and for determining the duration of the illumination or the speed at which the lights flash.

In wired embodiments of the present invention, the control unit comprises a power source and control switch. The control unit is physically connected to the one or more light assemblies by means of elongated electrical cables. The light assemblies include a light source and may include their own power source, or may use the same power source as the control unit. Thus, the wired embodiment is substantially the same and lacks a wireless signal transmitter and wireless signal receivers.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A wearable signaling device, comprising:
a plurality of adjustable straps adapted to be secured to a limb of a user;
a light assembly secured to each of said plurality of adjustable straps, wherein said light assembly includes a light source;
a control unit in communication with said light assemblies adapted to cause one or more of said light assemblies to illuminate as desired by the user.

2. The wearable signaling device of claim 1, wherein said plurality of adjustable straps each comprise a loop of elastic material.

3. The wearable signaling device of claim 1, wherein said plurality of adjustable straps each comprise an elongated strap having a first end with a first fastener thereon and a second end with a second fastener thereon, wherein said first fastener and said second fastener can be removably engaged.

4. The wearable signaling device of claim 3, wherein said first fastener and said second fastener both comprise hook and loop fastening material.

5. The wearable signaling device of claim 1, wherein said light assembly comprises a conical shape.

6. The wearable signaling device of claim 1, wherein said light assembly comprises a first half that is clear and a second half that is tinted red.

7. The wearable signaling device of claim 1, wherein said light assemblies are permanently secured to said plurality of adjustable straps.

8. The wearable signaling device of claim 1, wherein said plurality of adjustable straps comprise fasteners thereon adapted to removably engage with said light assemblies such that said light assemblies can be removed from said plurality of adjustable straps.

9. The wearable signaling device of claim 1, wherein said light assembly further includes a wireless receiver adapted to receive signals from said control unit.

10. The wearable signaling device of claim 1, wherein said light assembly further includes a power source.

11. The wearable signaling device of claim 1, wherein said control unit is in wired communication with said light assemblies.

12. The wearable signaling device of claim 1, wherein said control unit is in wireless communication with said light assemblies and includes a wireless transmitter adapted to wirelessly communicate with said light assemblies such that said light assemblies can be illuminated.

13. The wearable signaling device of claim 1, wherein said control unit includes one or more control switches adapted to cause said one or more of said light assemblies to illuminate.
